(19) United States
(12) Patent Application Publication
(10) Pub. No.: US 2025/0369439 A1
(43) Pub. Date: Dec. 4, 2025

(54) PROGRESSIVE CAVITY PUMP ROTOR

(71) Applicant: NATIONAL OILWELL VARCO, L.P., Houston, TX (US)

(72) Inventors: Cory Nesbitt, Rosenberg, TX (US); Noman Iqbal, Houston, TX (US); Kevin Retherford, Pearland, TX (US); Dib Elias Dib, Missouri City, TX (US); Christopher Simon Podmore, Houston, TX (US); Michael Davies, Stockport (GB); Andrew Morris, Glossop (GB)

(21) Appl. No.: 18/680,394

(22) Filed: May 31, 2024

(51) Int. Cl. F04C 2/107

(52) U.S. Cl. CPC F04C 2/1071; F04C 2230/60

(57) ABSTRACT

A progressive cavity pump rotor can include a scroll portion, which can be configured to interface with a stator, and a head portion, which can be configured to be coupled to a coupling rod with a non-collinear joint, where the scroll portion can be releasably coupled to the head portion with a collinear joint.

### TECHNICAL FIELD

The present disclosure relates to progressive cavity pumps, and more particularly, but not by way of limitation, to progressive cavity pump rotors.

### BACKGROUND

The background description provided herein is intended to generally present the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A progressive cavity pump can be a positive displacement pump and may also be referred to as an eccentric screw pump, or a cavity pump. Progressive cavity pumps may include a stator with a helically shaped cavity and a helically shaped rotor arranged in the cavity of the stator. The rotor may be rotated in the stator, which may cause the transfer of fluids through a sequence of progressing cavities, which can be formed between the stator and rotor.

### SUMMARY

In an example, a progressive cavity pump rotor can include a scroll portion, which can be configured to interface with a stator, and a head portion, which can be configured to be coupled to a coupling rod with a non-collinear joint, where the scroll portion can be releasably coupled to the head portion with a collinear joint.

In an example, a method of manufacturing a progressive cavity pump rotor can include manufacturing a scroll portion, which can be configured to interface with a stator. The method can also include manufacturing a head portion, which can be configured to be coupled to a coupling rod with a non-collinear joint. The method can also include attaching the scroll portion to the head portion with a collinear joint.

In an example, a progressive cavity pump rotor can include a scroll portion, which can be configured to interface with a stator, a head portion, which can be configured to be coupled to a coupling rod with a non-collinear joint, and a support buttress, which can be configured to limit a surface angle of a material included in the rotor measured with respect to a longitudinal axis of the rotor to below a specified angle.

### BRIEF DESCRIPTION OF THE DRAWINGS

In the drawings, which may not be drawn to scale, like numerals may describe substantially similar components throughout one or more of the views. Like numerals having different letter suffixes may represent different instances of substantially similar components. The drawings illustrate generally, by way of example but not by way of limitation.

FIG. 1 shows a perspective view of an example of portions of a progressive cavity pump system.

FIG. 2 shows a side view of the progressive cavity pump system of FIG. 1.

FIG. 3 shows a cross-sectional view of the progressive cavity pump system of FIG. 1.

FIG. 4 shows a close-up perspective view of the rotor of FIG. 1.

FIG. 5 shows an exploded perspective view of the rotor of FIG. 4.

FIG. 6 shows an exploded cross-sectional perspective view of the rotor of FIG. 4.

FIG. 7 shows a cross sectional view of the scroll portion of the rotor of FIG. 4.

FIG. 8 shows a diagram depicting a method of manufacturing a progressive cavity pump rotor.

### DETAILED DESCRIPTION

A progressive cavity pump rotor can be configured to have one or more of a specified weight (e.g., a reduced weight for a specified strength or stiffness, which can be achieved by reducing a material thickness), an even or substantially consistent wall thickness (e.g., in a hollow rotor, the thickness of the wall is substantially consistent across at least a portion of the rotor), or a specified radial weight distribution (e.g., an even or substantially consistent radial weight distribution), which can reduce vibrations or wobbling during rotation of the rotor.

A progressive cavity pump rotor can be manufactured through a subtractive manufacturing process, such as machining. However, it can be difficult to manufacture a rotor with a reduced weight, an even wall thickness, or both, using a subtractive manufacturing process. Additive manufacturing (e.g., 3D printing) can be used, which can help to reduce a weight of the rotor, provide an even wall thickness, and/or provide a specified radial weight distribution. However, portions of the rotor can be one or more of slow to additively manufacture, less strong when additively manufactured, or more expensive to additively manufacture.

A progressive cavity pump rotor can include portions that are additively manufactured and portions that are not additively manufactured (e.g., subtractively manufactured, molded, cast, welded, etc.). Two or more of the portions can be used in conjunction, fastened together, or both. This can help to provide a rotor that is one or more of less expensive to manufacture, stronger, has a more even wall thickness, or has a more even radial weight distribution, as compared to a rotor that is entirely additively manufactured or entirely subtractively manufactured.

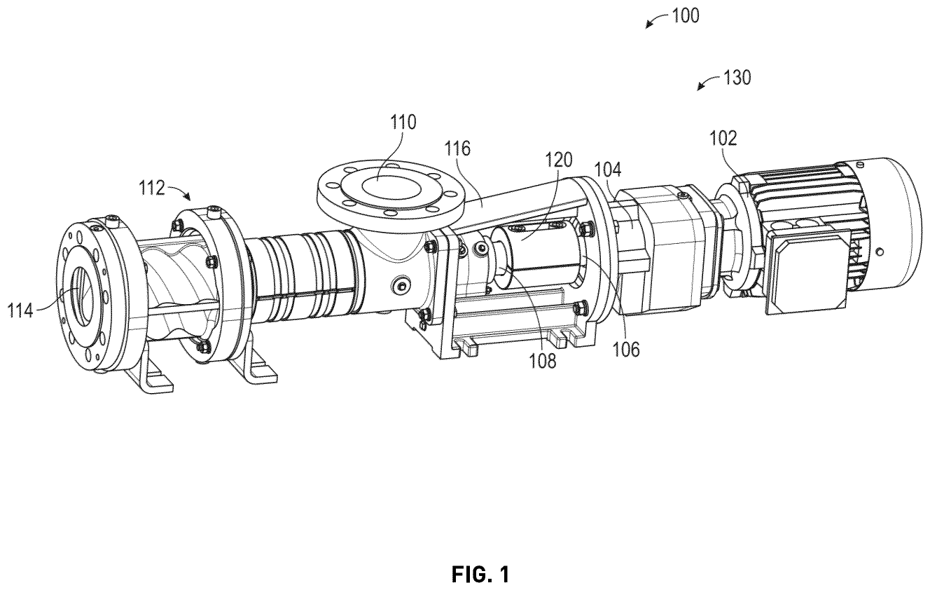

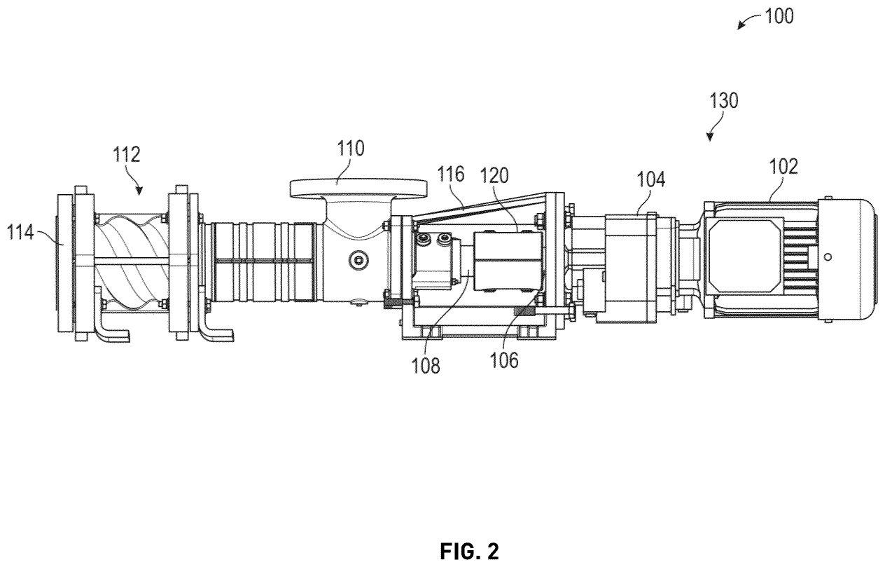

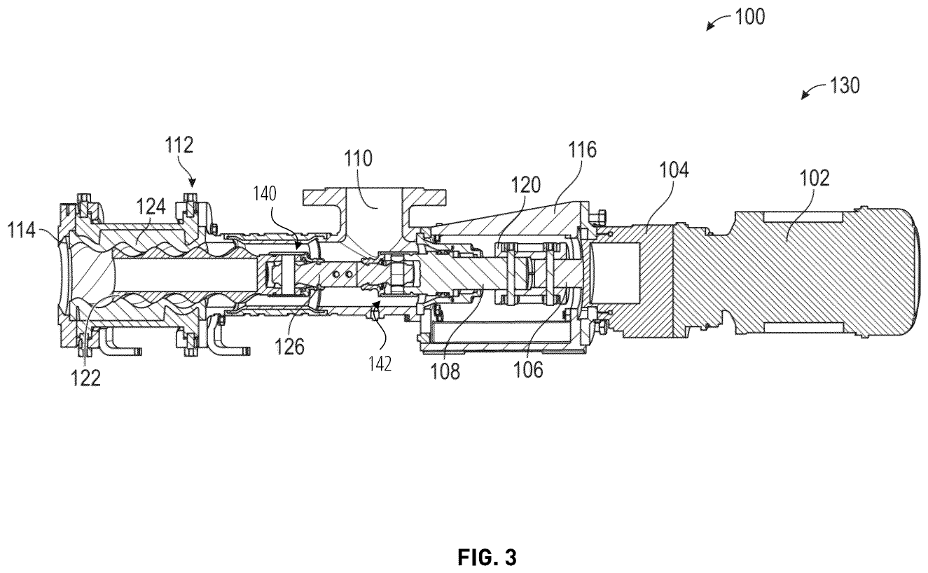

FIG. 1 through FIG. 3 show an example of portions of a progressive cavity pump system 100, and will be discussed together below. FIG. 1 shows a perspective view of an example of portions of a progressive cavity pump system 100. FIG. 2 shows a side view of the progressive cavity pump system 100 of FIG. 1. FIG. 3 shows a cross-sectional view of the progressive cavity pump system 100 of FIG. 1, where the cross section splits the progressive cavity pump system 100 vertically along a longitudinal axis. The progressive cavity pump system may be configured to pump fluids, slurries, sludges, or other flowable material. The progressive cavity pump system 100 can include a prime mover 130, a progressive cavity pump 112, a shaft coupling 120, and a housing 116.

The prime mover 130 can be configured to provide a motive force on the prime mover shaft 106, which can in turn provide a motive force to the progressive cavity pump 112 (e.g., through the shaft coupling 120). The prime mover 130 can include a motor 102 and a gearbox 104. The motor 102 can be coupled to the gearbox 104. The motor 102 can include an electric motor configured to generate rotational output power (e.g., torque) in a motor shaft from input electrical power. In an example, the motor 102 can be any form of power source, such as a combustion engine, a turbine engine, a hydraulic pump, etc. In an example, the prime mover 130 can include any device or system capable of providing a motive force to the progressive cavity pump 112, which can optionally include a gearbox 104 in addition to the motor 102.

The gearbox 104 can include a gearbox input shaft, which can be coupled to the motor shaft. The gearbox 104 can also include the prime mover shaft 106, which can be the output shaft of the gearbox 104. The gearbox 104 can change an angular velocity between the input shaft and the output shaft, change a mechanical advantage between the input shaft and the output shaft, or both. In an example, the gearbox 104 can decrease a rotational speed and increase a mechanical advantage between the input shaft and the output shaft.

With continued reference to FIGS. 1-3, the progressive cavity pump 112 of the system 100 may be described. The progressive cavity pump 112 may be configured to receive rotational power from the prime mover shaft 106 and pump and/or pressurize a flowable material using the rotational power operatively coupled to a positive displacement mechanism. More particularly, the progressive cavity pump 112 can include a fluid inlet 110, a fluid outlet 114, a power input shaft 108, a rotor 122, a stator 124, and a coupling rod 126.

The fluid inlet 110 can be arranged on a side of the progressive cavity pump 112. The fluid inlet 110 can receive the fluid to be pumped. The fluid inlet 110 can receive a fluid at a positive pressure (e.g., pre-pressurized), a negative pressure (e.g., suction head), or ambient pressure. The fluid outlet 114 can be arranged on the longitudinal end of the progressive cavity pump 112. The fluid outlet 114 can provide the pumped and/or pressurized fluid from the progressive cavity pump 112.

The rotor 122 can be configured to mesh with the stator 124. The rotor 122 and the stator 124 can be configured to generate a series of proceeding cavities when the rotor 122 is rotated within the stator 124. This series of proceeding cavities can move fluid from the fluid inlet 110 to the fluid outlet 114. The rotor 122 can include a helical shape (e.g., single helix (e.g., a single high lobe across 360 degrees at a specified cross section of the rotor 122), a double helix (e.g., two high lobes across 360 degrees)), and the stator 124 can include a corresponding helical shape, which can include a helical count that is one greater than the helical count of the rotor (e.g., a single helical rotor and a double helical stator (e.g., two indentations across 360 degrees at a specified cross section of the stator 124), a double helical rotor and a triple helical stator). When the rotor 122 rotates within the stator 124, a center axis of the rotor 122 can move with respect to a center axis of the stator 124. While the rotor has been described, generally, a particular rotor design is described in more detail below.

The coupling rod 126 can be configured to rotationally couple the rotor 122 to the power input shaft 108. The coupling rod 126 can be configured to accommodate an offset (e.g., a lateral offset in two parallel axes, an angular offset between two noncollinear axes) between an axis of the rotor 122 and an axis of the power input shaft 108. This can allow the axis of the power input shaft 108 to remain stationary with respect to an axis of the stator 124 while an axis of the rotor 122 moves with respect to an axis of the stator 124. The coupling rod 126 can include non-collinear couplings (e.g., universal joints) on one or both ends, which can allow the coupling rod 126 to be non-collinear with one or more of the rotor 122 or the power input shaft 108. There can be a first non-collinear joint 140 between the coupling rod 126 and the rotor 122. There can be a second non-collinear joint 142 between the coupling rod 126 and the power input shaft 108. In an example, the coupling rod 126 can include a gear joint coupling or a flexible shaft coupling.

In an example, the coupling rod 126 can include, be included in, or be replaced by a coupling system, which can be configured to couple the power input shaft 108 to the rotor 122. The coupling system can be configured to transfer torque from the power input shaft 108 to the rotor 122 and/or accommodate non-collinear longitudinal center axes of the rotor 122 and the power input shaft 108. For example, a longitudinal center axis of the rotor 122 may not be collinear (e.g., not aligned and/or not parallel) to a longitudinal center axis of the power input shaft 108 at one or more times. This can be due to an eccentric motion of the rotor 122. The coupling system can include one or more of a rigid coupling rod (e.g., which can include universal joints on one or both ends), a flexible coupling rod (e.g., which may or may not include universal joints on one or both ends), or a gear joint coupling (e.g., which may be used in conjunction with a rigid coupling rod, such as in place of a universal joint). The coupling system can include one or more collinear joints and/or one or more non-collinear joints.

The housing 116 can be configured to be mounted to the prime mover 130, the progressive cavity pump 112, or both. The housing 116 may connect the prime mover 130 to the progressive cavity pump 112. The housing 116 can be a substantially rigid frame, which can result in the housing 116 holding the prime mover 130 and the progressive cavity pump 112 in a substantially consistent orientation. The prime mover shaft 106 can extend partially into (e.g., through) the housing 116. The power input shaft 108 can extend partially into the housing 116.

The shaft coupling 120 can be configured for coupling the prime mover shaft 106 to the power input shaft 108. The shaft coupling 120 can be positioned within the housing 116. The shaft coupling 120 can be positioned between the progressive cavity pump 112 and the prime mover 130.

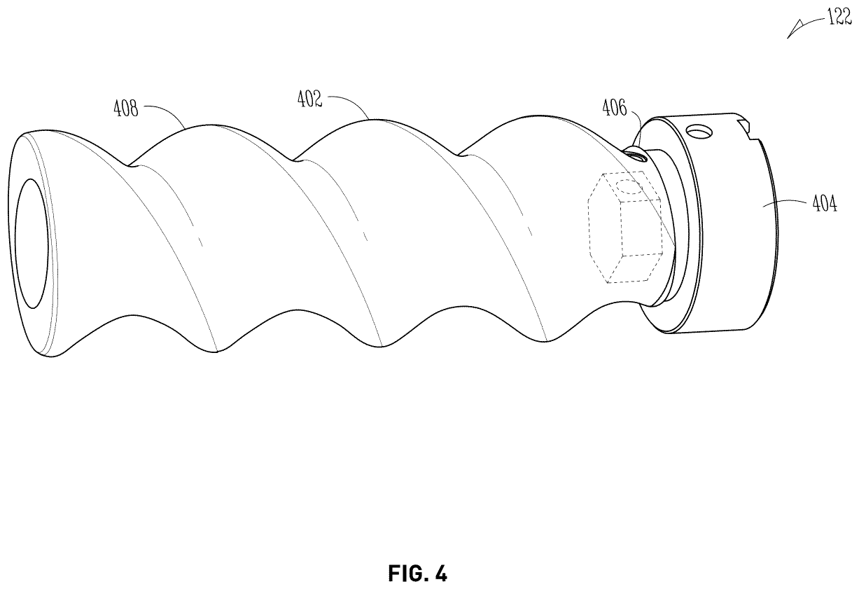

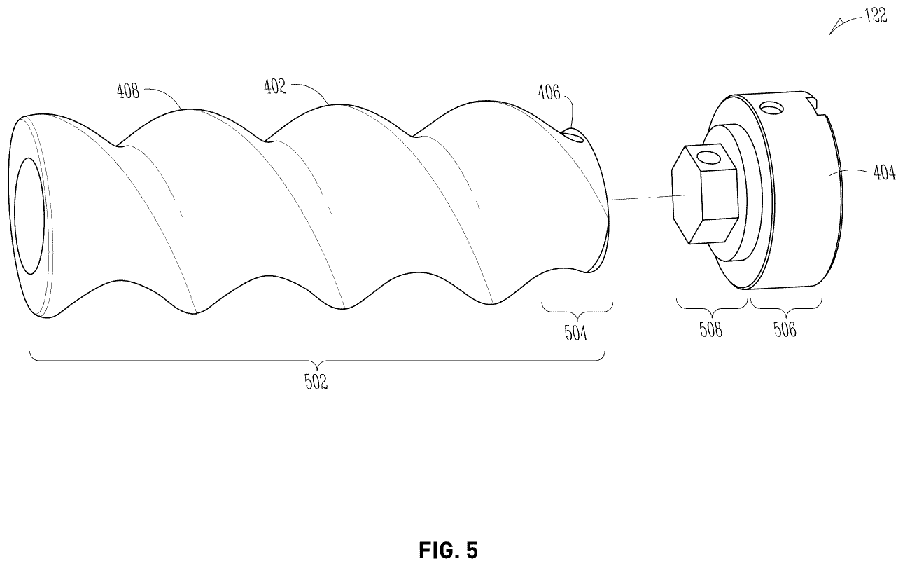

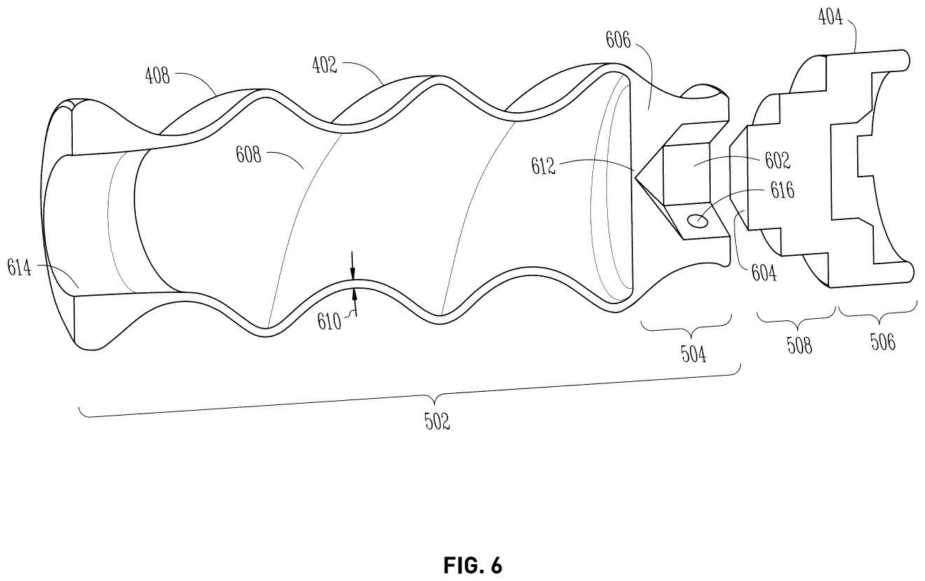

Turning back to the rotor to discuss a particular design, FIG. 4 shows a close-up perspective view of the rotor of FIG. 1. FIG. 5 shows an exploded perspective view of the rotor of FIG. 4. FIG. 6 shows an exploded cross-sectional perspective view of the rotor of FIG. 4. FIG. 4 through FIG. 6 will be discussed together below.

The rotor 122 can include a scroll portion 402 and a head portion 404. The scroll portion 402 can be configured to interface with the stator 124 to form a series of progressing cavities when the scroll portion 402 is rotated with respect to the stator 124. The scroll portion 402 can be a generally elongated member with one or more lobes on the outer surface in the form of a helical shape 408. The general diameter of the scroll portion 402 can remain consistent across the length of the scroll portion 402, or the diameter can vary in one or more locations. The scroll portion 402 can be substantially rotationally symmetric about the center axis of the rotor 122. The scroll portion 402 can be configured to be releasably coupled to the head portion 404 with a collinear joint. For example, the scroll portion 402 and the head portion 404 can act as substantially one piece when they are coupled. The center axis of the scroll portion 402 can be held substantially collinear with the center axis of the head portion 404.

The scroll portion 402 can include a helical portion 502, which can define a helical shape 408 (e.g., a helically shaped surface). The helical portion 502 can extend across all or substantially all of the longitudinal length of the scroll portion 402, or the helical portion 502 can extend across a more limited portion of the longitudinal length of the scroll portion 402 (e.g., 75 percent of the axial length). In an example, the helical portion 502 can extend to one or both ends of the scroll portion 402, which can include extending to the longitudinal end of the scroll portion 402 that interfaces with the head portion 404. The helical portion 502 can include a two-lead helical shape (e.g., two-lobe helical shape), as shown in FIG. 5. In an example, the helical portion 502 can include a helical shape with any number of leads (e.g., one lead, two leads, three leads, four leads, five or more leads (e.g., nine leads)). The stator 124 can be configured to interface with the helical portion 502, which can include the stator having one more lead than the helical portion 502.

The scroll portion 402 can include a first interface portion 504, which can be configured to interface with the head portion 404. The first interface portion 504 can be arranged on an end of the scroll portion 402 towards the head portion 404. The first interface portion 504 can include a socket (e.g., the hexagonal socket 602). The first interface portion 504 can extend across a portion of the axial length of the scroll portion 402, which can include five percent of the axial length, 10 percent of the axial length, 15 percent of the axial length, or any other portion. FIG. 5 shows that the first interface portion 504 can overlap or be included within the helical portion 502. For example, the first interface portion 504, which can be configured for interfacing with the head portion 404, can also include a portion of the helical shape 408 on the outer edge of the first interface portion 504 (e.g., the first interface portion 504 can be configured to connect to the head portion 404 while also optionally including a portion of the helical shape 408 on the outer surface), which can be configured to interface with the stator 124.

The head portion 404, can be configured to be coupled (e.g., releasably coupled) to the coupling rod 126 by the first non-collinear joint 140. The head portion 404 can be configured to transfer torque from the coupling rod 126 (e.g., which can receive torque from the power input shaft 108) to the scroll portion 402, which can provide the motive force to pump or pressurize a fluid within the progressive cavity pump 112. The head portion 404 can also be configured to be releasably coupled to the scroll portion 402.

The head portion 404 can include a coupling rod portion 506, which can be configured to be coupled to the coupling rod by the first non-collinear joint 140. The scroll portion 402 can include a socket on the coupling rod portion 506, which can be configured to receive a portion of a non-collinear joint (e.g., a portion of a universal joint, such as a ball and pin). The head portion 404 can include a second interface portion 508, which can be configured to interface with the first interface portion 504. The second interface portion 508 can include a protrusion (e.g., the hexagonal protrusion 604). FIG. 5 shows that the second interface portion 508 can be separated from the coupling rod portion 506. For example, the coupling rod portion 506 might not overlap axially with the second interface portion 508. In an example, the second interface portion 508 can overlap with the coupling rod portion 506. In an example, one or both of the second interface portion 508 and the coupling rod portion 506 can extend across all or substantially all of the axial length of the head portion 404. In an example, a portion of the head portion 404 can include a helical shape, which can be configured to operate in tandem with the helical portion 502 within the stator 124. In an example, the coupling rod portion 506 can be configured to couple to any coupling system, whether it includes a coupling rod or not. The coupling rod portion 506 can be configured to couple to the coupling system with a collinear joint or a non-collinear joint. In the example of a flexible coupling rod, the first non-collinear joint 140 can be replaced by a collinear joint.

The head portion 404 can be distinct from the coupling system in that a center axis of the head portion 404 can be collinear with the scroll portion 402, whereas a center axis of the head portion 404 might not be collinear with a center axis of the coupling system (e.g., not collinear with a center axis of a rigid coupling rod or a flexible coupling rod (e.g., the head portion 404 may be collinear with a portion of the center axis of the flexible coupling rod, but not the entire center axis of the flexible coupling rod because the flexible coupling rod is bent)).

In an example, the scroll portion 402 can be located towards the fluid output (e.g., the fluid outlet 114) from the head portion 404. The head portion 404 can be located towards a fluid intake (e.g., the fluid inlet 110) from the scroll portion 402.

The first interface portion 504 can be configured to interface with the second interface portion 508. For example, one of the portions can include a socket configured to interface with a protrusion on the other of the portions. In the example of FIG. 6, the first interface portion 504 can include a hexagonal socket 602 and the second interface portion 508 can include a hexagonal protrusion 604. The hexagonal socket 602 can be configured to interface with the hexagonal protrusion 604. For example, the hexagonal socket 602 can be sized or shaped so that when the hexagonal protrusion 604 is inserted into the hexagonal socket 602, the rotation of the hexagonal protrusion 604 with respect to the hexagonal socket 602 is limited. For example, the hexagonal protrusion 604 can be sized to provide a specified gap between the hexagonal protrusion 604 and the hexagonal socket 602, which can include a press fit (e.g., limited or no gap).

In an example, the first interface portion 504 and/or the second interface portion 508 can be configured differently. For example, the protrusion can be of any shape (e.g., round, triangular, square, octagonal, a non-regular polygon) and/or size. The hexagonal socket can be configured to match the protrusion (e.g., round, triangular, square, octagonal, a non-regular polygon), or can have a shape and/or size that differs from the protrusion. In an example, the first interface portion 504 can include the protrusion and the head portion 404 can include the socket.

The first interface portion 504 can include one or more threaded holes 616, which can be configured to receive set screws. One or more of the threaded holes 616 can begin on an outer surface of the scroll portion 402 (e.g., the helical shape 408 and can pass through to an outer wall of the hexagonal socket 602. The threaded hole 616 can be configured so that set screws in the threaded hole 616 impinge on the second interface portion 508 when they are tightened, which can include impinging on the hexagonal protrusion 604. The set screws can provide a specified degree or radial rigidity to the system (e.g., by removing slop, play, or other freedom of movement between the hexagonal socket 602 and the hexagonal protrusion 604), provide a specified level of resistance to separating the scroll portion 402 from the head portion 404, or both. The threaded hole 616 can be of any diameter, thread pitch, or thread standard. In an example, another method of retaining the scroll portion 402 and the head portion 404 together can be provided, alternatively or in addition to the threaded hole 616. For example, the scroll portion 402 and the head portion 404 can be joined through a pressure or interference fit. In an example, an axial retention screw can be used to connect the scroll portion 402 to the head portion 404. For example, a screw can pass through a hole in the scroll portion 402 and thread into a threaded hole in the head portion 404, where a head of the screw can bear against the scroll portion 402. The screw can be directed along any axis, which can include being directed along the longitudinal axis of the rotor 122.

The scroll portion 402 can include one or more support buttresses 606. The support buttress 606 can be configured to limit a surface angle of a material comprising the scroll portion measured with respect to a radial axis of the scroll portion to above a specified angle. The support buttress 606 can be located between the helical portion 502 and the first interface portion 504. In the example of FIG. 6, where the hexagonal socket 602 overlaps with the first interface portion 504, this can include the support buttress 606 being located between an end of the first interface portion 504 and the nonoverlapping portion of the helical portion 502.

A portion of the scroll portion 402 can be hollow. For example, the scroll portion 402 can include a hollow cavity 608, which can extend across a portion of the helical portion 502. A portion of the scroll portion 402 can include an even or substantially even wall thickness 610. For example, an outer surface of the hollow cavity 608 can substantially mirror the helical shape 408, which can result in the portion of the scroll portion 402 where the hollow cavity 608 exists having a substantially even wall thickness 610. The even wall thickness 610 can reduce a weight of the scroll portion 402 (e.g., as compared to a non-hollow scroll portion 402, a scroll portion 402 without an even wall thickness, or both), can create a more even longitudinal axial or radial distribution of weight (e.g., as compared to a non-hollow scroll portion 402, a scroll portion 402 without an even wall thickness, or both), which can reduce a level of vibration when the scroll portion 402 is rotated, or both.

In an example, one or more longitudinal ends of the scroll portion 402 can be enclosed (e.g., the material of the scroll portion 402 is continuous across the end). In an example, one or more of the longitudinal ends of the scroll portion 402 can be open (e.g., the material of the scroll portion 402 is not continuous across the end, which can provide an opening to the hollow cavity 608. FIG. 6 shows that the scroll portion 402 can include an enclosed end 612 and an open end 614. The enclosed end 612 can be arranged nearer the head portion 404, and can be formed in part by the support buttress 606. The open end 614 can be arranged away from the head portion 404, and can provide an opening to the hollow cavity 608.

The scroll portion 402 can be manufactured of any material, which can include metal, composite (e.g., resin fiber composite), plastic, or rubber. The scroll portion 402 can include the same material throughout the entire scroll portion 402, or the material can differ from one portion to another. In an example, the scroll portion 402 can be manufactured using an additive manufacturing process, which can include laser powder bed fusion (LPBF). In an example, the scroll portion 402 can be manufactured using a subtractive manufacturing process, such as machining using one or more of a lathe, drill, or mill. In an example, the scroll portion 402 can be manufactured using both an additive and a subtractive manufacturing process. For example, the scroll portion 402 can be manufactured using LPBF, and then the threaded hole 616 can be machined (e.g., the hole, threads within the hole, or both can be machined).

The head portion 404 can be manufactured of any material, which can include metal, composite (e.g., resin fiber composite), plastic, or rubber. The head portion 404 can include the same material throughout the entire head portion 404, or the material can differ from one portion to another. The head portion 404 can include a material that is the same as the scroll portion 402, or the materials can differ. In an example, the head portion 404 can be manufactured using an additive manufacturing process, which can include laser powder bed fusion (LPBF). In an example, the head portion 404 can be manufactured using a subtractive manufacturing process, such as machining using one or more of a lathe, drill, or mill. In an example, the head portion 404 can be manufactured using both an additive and a subtractive manufacturing process.

In an example, the scroll portion 402 can be manufactured at least in part using an additive manufacturing process, and the head portion 404 can be manufactured without using an additive manufacturing process. For example, the scroll portion 402 can be more suited to additive manufacturing processes (e.g., due to the even wall thicknesses), and the head portion 404 can be more suited to subtractive manufacturing processes (e.g., because the shape of the head portion 404 allows for efficient machining). Because the scroll portion 402 is releasably coupled to the head portion 404, the scroll portion 402 can be manufactured separate from the head portion 404 (e.g., using a different manufacturing process), and then the scroll portion 402 and the head portion 404 can be combined.

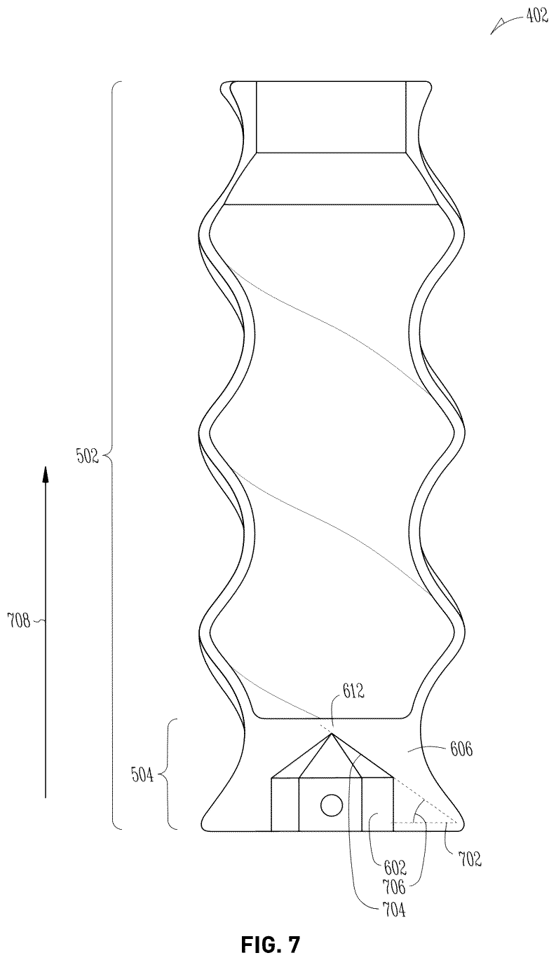

FIG. 7 shows a cross sectional view of the scroll portion 402 of the rotor 122 of FIG. 4. In the example of FIG. 7, the scroll portion 402 can be manufactured substantially through additive manufacturing. FIG. 7 shows the direction of additive manufacturing 708. FIG. 7 shows that the scroll portion 402 can be additively manufactured starting with the first interface portion 504.

Manufacturing the enclosed end 612 can include establishing (e.g., building) a bridge structure over the hexagonal socket 602. The bridge structure can be or include one or more support buttresses 606. The support buttresses 606 can be configured to keep the material surface angle 706 formed between the material surface axis 704 and the horizontal axis 702 (e.g., the horizontal axis during the additive manufacturing process, which can be orthogonal to the direction of additive manufacturing 708) above a specified angle.

The support buttresses 606 might be included only to keep the material surface angle 706 of one or more portions of the scroll portion 402 above the specified angle, or the support buttresses 606 can serve one or more other purposes (e.g., adding strength).

The specified angle can be selected based on the additive manufacturing process, the additive manufacturing system, or both. The specified angle can be related to the overhang that can be additively manufactured. For example, it may be difficult or impossible to additively manufacture a feature with a material surface angle 706 of 0 degrees (e.g., an unsupported horizontal surface). A minimum material surface angle 706 greater than 0 degrees can be specified or determined (e.g., determined through testing), which can introduce a need for support buttresses 606 in a rotor configuration. The additively manufactured portions of the rotor 122 (e.g., portions of the scroll portion 402, portions of the head portion 404, or both) can include one or more support buttresses 606.

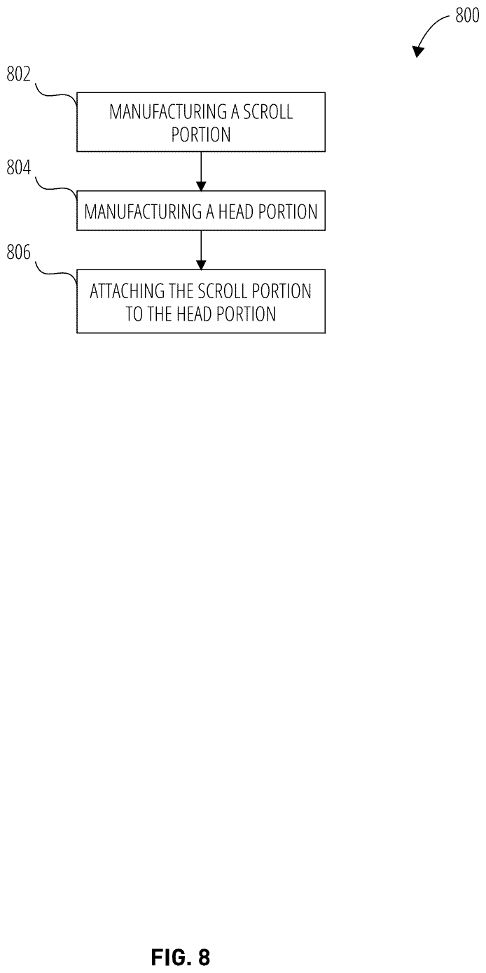

FIG. 8 shows a diagram depicting a method of manufacturing a progressive cavity pump rotor, such as the rotor 122 of the progressive cavity pump system 100. At step 802 a scroll portion (e.g., the scroll portion 402) can be manufactured. The scroll portion can be configured to interface with a stator (e.g., the stator 124), such as discussed above. Manufacturing the scroll portion can include using an additive manufacturing process, such as LPBF. In an example, manufacturing the scroll portion can include using a subtractive manufacturing process, such as machining. The subtractive manufacturing process can occur before, during, or after the additive manufacturing process. In an example, the form of the scroll portion can be additively manufactured, and then one or more features (e.g., threaded holes, seal slots, etc) can be machined into the additively manufactured scroll portion.

At step 804, a head portion (e.g., the head portion 404) can be manufactured. The head portion can be configured to be coupled to a coupling rod (e.g., the coupling rod 126), such as with a non-collinear joint (e.g., the first non-collinear joint 140). Manufacturing the head portion can include using a subtractive manufacturing process. The subtractive manufacturing process can include machining using a lathe. For example, the head portion can be formed from a solid or substantially solid block or billet, which can be machined (e.g., using lathes, mills, drills) to form the head portion. In an example, the head portion can be manufactured without using an additive manufacturing process. In an example, fabrication processes (e.g., welding) can be distinct from additive manufacturing processes (e.g., 3D printing).

At step 806, the scroll portion can be attached to the head portion. This can include attaching the scroll portion to the head portion with a collinear joint. For example, the hexagonal protrusion 604 can be engaged with the hexagonal socket 602, a set screw in the threaded hole 616 can be tightened, or both.

The method 800 can also include installing the rotor (e.g., the scroll portion attached to the head portion) in a progressive cavity pump. In an example, the method 800 can include replacing the scroll portion, such as while leaving the head portion installed in the progressive cavity pump. For example, the head portion can remain coupled to the coupling rod by a non-collinear joint, while the rotor portion is detached from the head portion, removed from the progressive cavity pump, and replaced (e.g., replaced after cleaning or remanufacturing, replaced with a new rotor scroll portion). Following replacing the scroll portion, the scroll portion and the head portion can be attached, such as at step 806.

The shown order of steps is not intended to be a limitation on the order in which the steps are performed. In an example, two or more steps may be performed simultaneously or at least partially concurrently.

The following, non-limiting examples, detail certain aspects of the present subject matter to solve the challenges and provide the benefits discussed herein, among others.

### EXAMPLES

Example 1 is a progressive cavity pump rotor, comprising: a scroll portion, configured to interface with a stator; and a head portion, configured to be coupled to a coupling rod with a non-collinear joint, wherein the scroll portion is releasably coupled to the head portion with a collinear joint.

In Example 2, the subject matter of Example 1 optionally includes wherein the scroll portion includes: a helical portion, defining a helical shape; and a first interface portion, configured to interface with the head portion.

In Example 3, the subject matter of Example 2 optionally includes wherein the head portion includes: a coupling rod portion, configured to be coupled to the coupling rod; and a second interface portion, configured to interface with the first interface portion.

In Example 4, the subject matter of Example 3 optionally includes wherein the first interface portion includes a hexagonal socket configured to interface with a hexagonal protrusion on the second interface portion.

In Example 5, the subject matter of any one or more of Examples 2-4 optionally include wherein the scroll portion includes: a support buttress, configured to limit a surface angle of a material comprising the scroll portion measured with respect to a radial axis of the scroll portion to above a specified angle.

In Example 6, the subject matter of Example 5 optionally includes wherein the support buttress is located between the helical portion and the first interface portion.

In Example 7, the subject matter of any one or more of Examples 1-6 optionally include wherein at least a portion of the scroll portion is hollow.

In Example 8, the subject matter of Example 7 optionally includes wherein at least a portion the scroll portion includes an even wall thickness.

In Example 9, the subject matter of any one or more of Examples 7-8 optionally include wherein at least one of a first end or a second end of the scroll portion along a longitudinal axis is enclosed.

In Example 10, the subject matter of any one or more of Examples 1-9 optionally include wherein the scroll portion includes a two-lead helical shape.

In Example 11, the subject matter of any one or more of Examples 1-10 optionally include wherein: the scroll portion is located towards a fluid output from the head portion; and the head portion is located towards a fluid intake from the scroll portion.

Example 12 is a method of manufacturing a progressive cavity pump rotor, comprising: manufacturing a scroll portion, configured to interface with a stator; manufacturing a head portion, configured to be coupled to a coupling rod with a non-collinear joint; and attaching the scroll portion to the head portion with a collinear joint.

In Example 13, the subject matter of Example 12 optionally includes manufacturing the scroll portion using an additive manufacturing process.

In Example 14, the subject matter of Example 13 optionally includes wherein the additive manufacturing process includes laser powder bed fusion.

In Example 15, the subject matter of any one or more of Examples 13-14 optionally include manufacturing the head portion using a subtractive manufacturing process.

In Example 16, the subject matter of Example 15 optionally includes wherein the subtractive manufacturing process includes machining using a lathe.

In Example 17, the subject matter of any one or more of Examples 12-16 optionally include installing the rotor in a progressive cavity pump; and replacing the scroll portion while leaving the head portion installed in the progressive cavity pump.

Example 18 is a progressive cavity pump rotor, comprising: a scroll portion, configured to interface with a stator; a head portion, configured to be coupled to a coupling rod with a non-collinear joint; and a support buttress, configured to limit a surface angle of a material comprising the rotor measured with respect to a longitudinal axis of the rotor to below a specified angle.

In Example 19, the subject matter of Example 18 optionally includes wherein at least a portion of the scroll portion is hollow and includes an even wall thickness.

In Example 20, the subject matter of Example 19 optionally includes wherein the scroll portion is releasably coupled to the head portion with a collinear joint.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

In example 25, any one or more of the above examples can include a coupling system, alternatively or in addition to one or more of the coupling rod or the non-collinear joint.

Each of the non-limiting aspects above can stand on its own or can be combined in various permutations or combinations with one or more of the other aspects or other subject matter described in this document.

The above detailed description includes references to the accompanying drawings, which form a part of the detailed description. The drawings show, by way of illustration, specific examples that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the terms “or” and “and/or” are used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5). Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4).

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Such instructions can be read and executed by one or more processors to enable performance of operations comprising a method, for example. The instructions are in any suitable form, such as but not limited to source code, compiled code, interpreted code, executable code, static code, dynamic code, and the like.

Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other examples may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the examples should be determined with reference to the appended claims, along with the full scope of equivalents to which such claims are entitled.

1. A progressive cavity pump rotor, comprising:
a scroll portion, configured to interface with a stator; and
a head portion, configured to be coupled to a coupling system that accommodates an eccentric motion between the head portion and a power input shaft, wherein the scroll portion is releasably coupled to the head portion with a collinear joint.

2. The progressive cavity pump rotor of claim 1, wherein the scroll portion includes:
a helical portion, defining a helical shape; and
a first interface portion, configured to interface with the head portion.

3. The progressive cavity pump rotor of claim 2, wherein the head portion includes:
a coupling system portion, configured to be coupled to the coupling system; and
a second interface portion, configured to interface with the first interface portion.

4. The progressive cavity pump rotor of claim 3, wherein the first interface portion includes a hexagonal socket configured to interface with a hexagonal protrusion on the second interface portion.

5. The progressive cavity pump rotor of claim 2, wherein the scroll portion includes:
a support buttress, configured to limit a surface angle of a material comprising the scroll portion measured with respect to a radial axis of the scroll portion to above a specified angle.

6. The progressive cavity pump rotor of claim 5, wherein the support buttress is located between the helical portion and the first interface portion.

7. The progressive cavity pump rotor of claim 1, wherein at least a portion of the scroll portion is hollow.

8. The progressive cavity pump rotor of claim 7, wherein at least a portion the scroll portion includes an even wall thickness.

9. The progressive cavity pump rotor of claim 7,
wherein at least one of a first end or a second end of the scroll portion along a longitudinal axis is enclosed.

10. The progressive cavity pump rotor of claim 1, wherein the scroll portion includes a two-lead helical shape.

11. The progressive cavity pump rotor of claim 1, wherein:
the scroll portion is located towards a fluid output from the head portion; and
the head portion is located towards a fluid intake from the scroll portion.

12. A method of manufacturing a progressive cavity pump rotor, comprising:
manufacturing a scroll portion, configured to interface with a stator;
manufacturing a head portion, configured to be coupled to a coupling system that accommodates an eccentric motion between the head portion and a power input shaft; and
attaching the scroll portion to the head portion with a collinear joint.

13. The method of claim 12, comprising:
manufacturing the scroll portion using an additive manufacturing process.

14. The method of claim 13, wherein the additive manufacturing process includes laser powder bed fusion.

15. The method of claim 13, comprising:
manufacturing the head portion using a subtractive manufacturing process.

16. The method of claim 15, wherein the subtractive manufacturing process includes machining using a lathe.

17. The method of claim 12, comprising:
installing the rotor in a progressive cavity pump; and
replacing the scroll portion while leaving the head portion installed in the progressive cavity pump.

18. A progressive cavity pump rotor, comprising:
a scroll portion, configured to interface with a stator;
a head portion, configured to be coupled to a coupling system that accommodates an eccentric motion between the head portion and a power input shaft, wherein the scroll portion is releasably coupled to the head portion with a collinear joint; and
a support buttress, configured to limit a surface angle of a material comprising the progressive cavity pump rotor measured with respect to a longitudinal axis of the progressive cavity pump rotor to below a specified angle.

19. The progressive cavity pump rotor of claim 18, wherein at least a portion of the scroll portion is hollow and includes an even wall thickness.

20. (canceled)

21. The progressive cavity pump rotor of claim 1, wherein:
the coupling system comprises a coupling rod; and
the head portion is configured to be coupled to the coupling rod with a non-collinear joint.
